(19) United States
(12) Patent Application Publication
(10) Pub. No.: US 2020/0215393 A1
(43) Pub. Date: Jul. 9, 2020

(54) METHODS FOR PHYSICAL THERAPY

(71) Applicant: Michelle Blackwell, Irvine, CA (US)

(72) Inventor: Michelle Blackwell, Irvine, CA (US)

(21) Appl. No.: 16/735,364

(22) Filed: Jan. 6, 2020

Related U.S. Application Data
(60) Provisional application No. 62/789,235, filed on Jan. 7, 2019.

(51) Int. Cl. A63B 24/00; A63B 26/00; A61H 15/00; A63B 21/055; A63B 71/06

(52) U.S. Cl. CPC A63B 24/0075; A63B 26/003; A61H 15/0092; A63B 2071/0694; A63B 71/06; A63B 2225/12; A63B 21/0552

(57) ABSTRACT

A method for physical therapy. The method includes having a plurality of visual indicators on a body of an individual, each visual indicator of the plurality of indicators corresponding to a unique location on the body. The method further includes establishing visual contact with, using a viewing apparatus, at least two of the plurality of visual indicators. The method further includes moving the body to vary a spatial relationship between the at least two of the plurality of visual indicators while in visual contact with the at least two of the plurality of visual indicators, to thereby produce a therapeutic effect for the individual.

### CROSS REFERENCE TO RELATED APPLICATIONS

This application claims the benefit of U.S. Provisional Patent Application No. 62/789,235 entitled “METHODS FOR PHYSICAL THERAPY” filed on Jan. 7, 2019, the entire contents of this application is hereby incorporated by reference herein.

### BACKGROUND

Patients suffering from a condition like scoliosis or recovering from a debilitating injury generally need some form of physical therapy to improve their mobility and function. One of the long-term goals of physical therapy is to assist the patient in creating a more natural and sustainable posture and/or movements through the creation of muscle memory. Muscle memory generally results from performing repetitive movements or tasks that train the patient's motor system to maintain a posture and/or perform a movement without conscious effort on the part of the patient. For example, a patient that is hunched over (e.g. suffering from excessive thoracic kyphosis) may correct their posture by repeatedly straightening out their back while standing and/or walking. After repeatedly training their motor system, the patient develops a muscle memory that allows them to stand and walk with their back straightened without conscious effort.

While a physical therapist could physically assist the patient in performing the proper movement or by physically correcting the patient's posture, this method has several drawbacks. First, it may require the physical therapist to physically contact and exert force against the patient. Second, it may be difficult for the patient to identify optimal movement form, as spatial disorientation is often a result of injury/pre-rehabilitation pathology. Third, it may not be the most efficient method at training the patient's motor system.

Thus, there is a need for a more effective physical therapy method.

### SUMMARY

In general, one aspect of the subject matter described in this specification is embodied in a method for physical therapy. The method may include having a plurality of visual indicators on a body of an individual, each visual indicator of the plurality of visual indicators corresponding to a unique location on the body. The method may include establishing visual contact with, using a viewing apparatus, at least two of the plurality of visual indicators. The method may include moving the body to vary a spatial relationship between the at least two of the plurality of visual indicators while in visual contact with the at least two of the plurality of visual indicators, to thereby produce a therapeutic effect for the individual. The spatial relationship may be a predetermined or objective spatial relationship. The therapeutic effect may include optimal anatomical alignment and/or a corrective movement pattern for the individual.

In another aspect, the subject matter is embodied in a method for physical therapy. The method may include having a plurality of visual indicators on a body of an individual, each visual indicator of the plurality of visual indicators corresponding to a unique location on the body. The method may include establishing visual contact with, using a viewing apparatus, at least two visual indicators of the plurality of visual indicators. The method may include moving the body to vary a spatial relationship between the at least two of the plurality of visual indicators while in visual contact with the at least two of the plurality of visual indicators. The method may include bouncing a ball off the viewing apparatus or an object. The method may include moving the body to vary the spatial relationship between the at least two of the plurality of visual indicators while in visual contact with the at least two of the plurality of visual indicators, to thereby produce a therapeutic effect for the individual.

In another aspect, the subject matter is embodied in a method for physical therapy. The method may include having at least one visual indicator on a body of an individual. The method may include establishing visual contact with, using a viewing apparatus, the at least one visual indicator. The method may include moving the body to vary a position of the at least one visual indicator while in visual contact with the at least one visual indicator, to thereby produce a therapeutic effect for the individual.

In another aspect, the subject matter is embodied in a method for physical therapy. The method may include having a plurality of visual indicators on a body of an individual, each visual indicator of the plurality of indicators corresponding to a unique location on the body. The method may include having the individual establish visual contact with, using a viewing apparatus, at least two of the plurality of visual indicators. The method may include instructing the individual to move the body to vary a spatial relationship between the at least two of the plurality of visual indicators while in visual contact with the at least two of the plurality of visual indicators, to thereby produce a therapeutic effect for the individual. The spatial relationship may be a predetermined or objective spatial relationship. The therapeutic effect may include optimal anatomical alignment and/or a corrective movement pattern for the individual.

### BRIEF DESCRIPTION OF THE DRAWINGS

The features and advantages of the embodiments of the present disclosure will become more apparent from the detailed description set forth below when taken in conjunction with the drawings. Naturally, the drawings and their associated descriptions illustrate example arrangements within the scope of the claims and do not limit the scope of the claims. Reference numbers are reused throughout the drawings to indicate correspondence between referenced elements.

FIGS. 1A-1D illustrate a method for physical therapy according to an embodiment of the present disclosure.

FIGS. 2A-2D illustrate a method for physical therapy according to an embodiment of the present disclosure.

FIGS. 3A-3D illustrate a method for physical therapy according to an embodiment of the present disclosure.

FIG. 4 illustrates a method for physical therapy according to an embodiment of the present disclosure.

FIG. 5 illustrates a plurality of visual indicators for a physical therapy method according to an embodiment of the present disclosure.

FIG. 6 illustrates a method for physical therapy according to an embodiment of the present disclosure.

FIGS. 7A-7B illustrate a method for physical therapy according to an embodiment of the present disclosure.

FIG. 8 illustrates a flowchart for a method for physical therapy according to an embodiment of the present disclosure.

FIG. 9 illustrates a flowchart for a method for physical therapy according to an embodiment of the present disclosure.

FIG. 10 illustrates a flowchart for a method for physical therapy according to an embodiment of the present disclosure.

FIG. 11 illustrates a flowchart for a method for physical therapy according to an embodiment of the present disclosure.

### DETAILED DESCRIPTION

In treating a condition like scoliosis or assisting in the recovery of a major injury, a physical therapist may physically assist the patient in adjusting their posture and/or performing physical movements. Assistance is usually in the form of tactile input to the patient of where and how the patient's body should be positioned.

Other forms of assistance may include auditory input to the patient. For example, the physical therapist may verbally instruct the patient regarding where and how the patient's body should be positioned. The patient will hear the auditory or verbal instructions of the physical therapist and attempt to follow the instructions.

Features of the present disclosure include methods of visual input to a patient. It is believed that visual input is a more efficient and effective way to provide physical therapy to a patient and to train one's motor system. Therefore, a more effective method at training a patient's motor system, through physical therapy, would incorporate visual input. Moreover, the methods may allow the patient to be able to accurately and precisely perform the physical training alone without the need of a physical trainer being present. The patient may have live-time neurofeedback, and may be able to adjust his or her body to a corrective posture in live-time or mid-exercise. The patient may be able to identify the adjustments needed without responding to tactile or auditory cues from a present physical therapist or other individual.

A method for physical therapy incorporating visual input may result in numerous benefits for the patient. The patient may be able to more rapidly train one's motor system in producing an adjusted resting posture and/or have a more rapid recovery. The patient and, if applicable, his or her insurance agency may save time and money by not necessarily needing to hire a physical therapist. Finally, by being able to perform the physical therapy on their own, patients may undoubtedly have a greater sense of accomplishment and well-being. The patient may also have a trained cognitive awareness of postural objectives. The postural objectives may translate to the functionality of any physical movement performed in the human body.

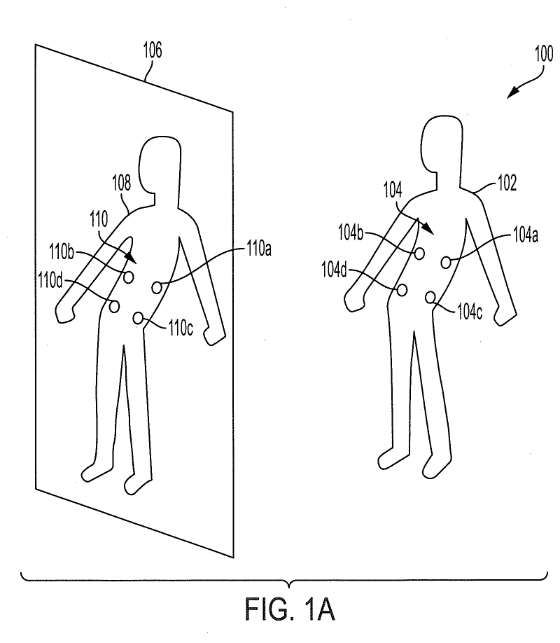

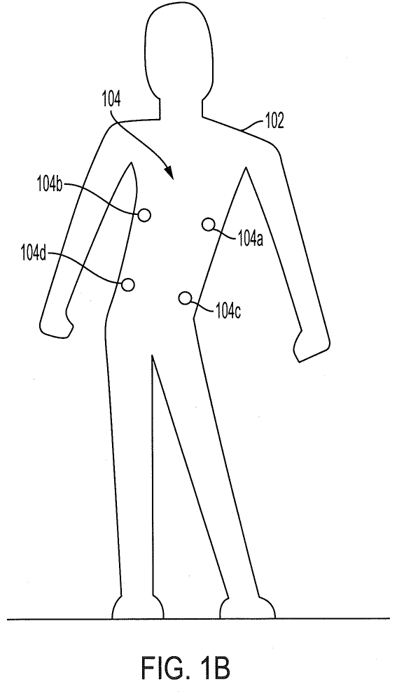

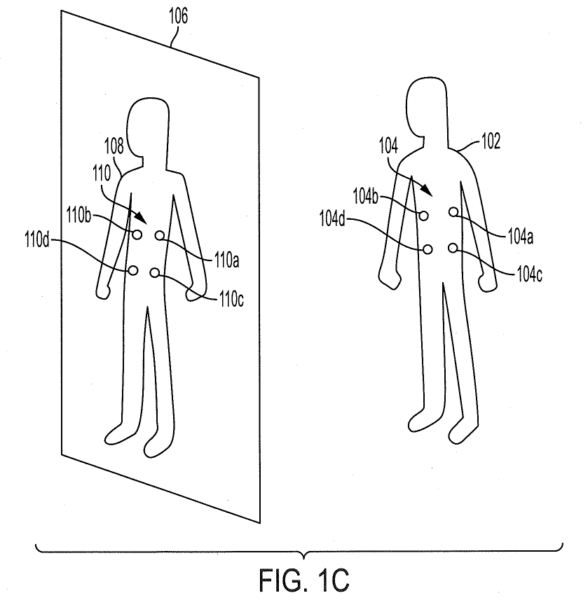

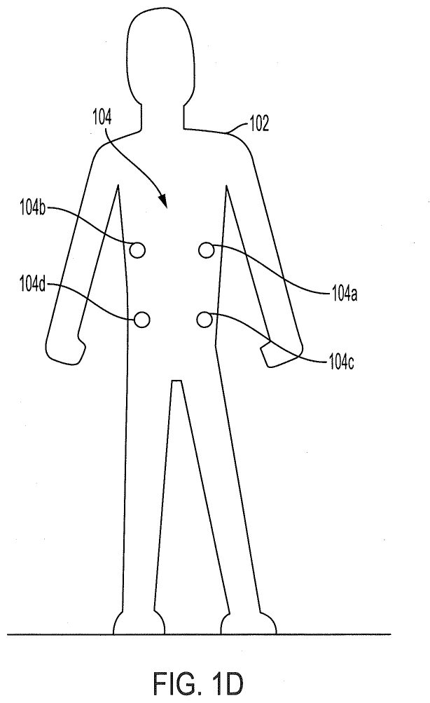

FIGS. 1A-1D illustrate a method 100 for physical therapy according to an embodiment of the present disclosure.

FIG. 1A illustrates a body 102 of an individual with scoliosis standing with a viewing apparatus 106 in front of the individual. The individual may be a patient undergoing a physical therapy. The body 102 is depicted as having an uneven posture in the form of a cross lateral latency that may be corrected through retraining of the patient's motor system.

Three cardinal anatomical planes may be used to describe spatial locations on the body 102. The sagittal plane divides the body 102 into left and right portions. The coronal plane divides the body 102 into posterior and anterior portions. The transverse plane divides the body 102 into head and tail portions.

A plurality of visual indicators 104 are positioned on the body 102 to provide spatial reference to the patient and/or another individual assisting the patient, such as a physical therapist or other health professional. The patient and another individual may have the plurality of visual indicators 104 on the body 102 of the patient, with each visual indicator 104 corresponding to a unique location on the body.

The plurality of visual indicators 104 are shown to include four visual indicators (104a, 104b, 104c, and 104d). However, any number of visual indicators may be used as desired (a greater or lesser number). Each visual indicator 104a, 104b, 104c, and 104d is positioned on a unique location of the body 102 that corresponds to a location within the sagittal, the coronal, and the transverse planes.

The positioning of the plurality of visual indicators 104 may be accomplished by drawing the visual indicators directly onto the body 102. For example, the plurality of visual indicators 104 may be drawn on the patient's skin using a pen or a marker. In other embodiments, the plurality of visual indicators 104 may be drawn onto the patient's clothing using a pen or marker.

The positioning of the plurality of visual indicators 104 may also be accomplished by attaching the visual indicators directly onto the body 102. For example, the plurality of visual indicators 104 may be in the form of one or more adhesive stickers that are attached to the patient's skin. In other embodiments, the positioning of the plurality of visual indicators 104 on the body 102 may be accomplished by attaching one or more adhesive stickers to the patient's clothing. The one or more adhesive stickers each may have an adhesive side for attaching directly to the patient's body or to the patient's clothing, and an opposite display side for being viewed by the patient.

The visual indicators 104a, 104b, 104c, and 104d are depicted as being circular in shape. However, other geometric shapes may be used as desired. The visual indicators 104a, 104b, 104c, and 104d may be in two-dimensional form or three-dimensional form.

The visual indicators 104a, 104b, 104c, and 104d may have a single color or include a mixture of colors. In some embodiments, the visual indicators 104a, 104b, 104c, and 104d may include a geometric pattern to assist the patient in quickly locating the visual indicators 104a, 104b, 104c, and 104d on his or her body 102. The visual indicators 104a, 104b, 104c, and 104d may have a matte surface or a reflective surface to allow the patient to align the visual indicators 104a, 104b, 104c, and 104d under various lighting conditions. For example, under poor lighting conditions a reflective surface may be used.

Either the patient or the other individual (such as a physical therapist) may position the visual indicators 104 on the body 102 of the patient such that the body 102 of the patient has the visual indicators 104. The other individual (such as a physical therapist), for example, may determine the desired positions of the visual indicators 104 such that movement of the body 102 causes variation of the spatial relationship between the visual indicators 104 that may produce a therapeutic effect for the patient.

The viewing apparatus 106 may be located in front of the patient and is depicted as being a floor length mirror. The viewing apparatus 106 may include at least one mirror. However, other forms of viewing apparatus may be used as desired. The viewing apparatus 106 may be configured as a device for the patient to view himself or herself. The viewing apparatus 106 may be configured to provide a live-time view of the patient for the patient. For example, in one embodiment the viewing apparatus may be an electronic screen. The electronic screen may display images that are taken by a camera viewing the patient. The images may be a live-time video feed of the patient. Other forms of viewing apparatuses 106 may be utilized as desired.

The viewing apparatus 106 may reflect or otherwise display the image of the body 102 and the plurality of visual indicators 104 back to the patient. The image of the body 102 is reflected back to the patient as body reflection 108. The plurality of visual indicators 104 may be similarly reflected back to the patient as visual indicator reflections 110. Visual indicator 104a is reflected back to the patient as visual indicator reflection 110a. Visual indicator 104b is reflected back to the patient as visual indicator reflection 110b. Visual indicator 104c is reflected back to the patient as visual indicator reflection 110c. Visual indicator 104d is reflected back to the patient as visual indicator reflection 110d.

The method may include physical therapy for the patient utilizing visual input provided by the viewing apparatus 106. The patient may establish visual contact with, using the viewing apparatus 106, at least two visual indicators of the plurality of visual indicators 104. The visual contact may allow the patient to visually track the visual indicators 104 as the patient's body 102 is moved. The patient may establish visual contact with at least two visual indicators. The patient may then move the body 102 to vary a spatial relationship between the at least two of the visual indicators 104 while in visual contact with the at least two of the visual indicators 104, to thereby produce a therapeutic effect for the individual.

The patient, while in visual contact with the at least two of the visual indicators 104, may receive live-time visual feedback on the movement of the patient's body 102 by viewing the at least two visual indicators 104. The visual indicators 104 may serve as a visual landmark that provides feedback regarding the movement of the body 102. It is believed that this method of visual contact with the visual indicators 104 provides an improved method of training the motor system of the body. The visual contact with the visual indicators 104 during movement may train the somatosensory motor neurons. The visual neuro-feedback provides a more effective method to train the patient's motor system to maintain a posture and/or perform a movement.

The body 102 may be moved in a variety of manners to vary the spatial relationship between the at least two visual indicators 104. The body 102 may be moved in response to an instruction from another individual (such as a physical therapist or other health professional) indicating a desired variation of the spatial relationship between the at least two visual indicators 104. The instruction may be auditory (verbal or other sounds) or may be a visual or tactile instruction. For example, the patient may be instructed to align at least two of the visual indicators 104. The patient may be instructed to align the at least two visual indicators 104 along a plane. For example, the patient may align the at least two visual indicators 104 along a vertical plane or a horizontal plane, or may align the at least two visual indicators 104 along a plane on or parallel to one of a sagittal plane, a coronal plane, or a transverse plane of the body 102 of the individual. The plane may be defined by an instruction provided to the patient. As another example, the body 102 may be moved such that the spatial relationship between the at least two visual indicators 104 is varied in another manner. For example, the body 102 may be moved such that one visual indicator 104 is moved closer to another visual indicator 104 or may be moved away from another visual indicator 104. The spatial relationships between the visual indicators 104 may be varied in a variety of manners.

The body 102 is preferably moved to vary the spatial relationship between at least two of the visual indicators 104 while in visual contact with the at least two of the plurality of visual indicators 104, to thereby produce a therapeutic effect for the patent. For example, the body 102 may be moved towards an improved posture for the patient, which may include moving the spine of the patient towards an upward extent in a vertical plane. The body 102 may be moved towards an improved posture by having the shoulders moved towards a raised posture. The body 102 may be moved to counteract a physical bias of the body, for example, a physical bias towards an undesired posture caused by scoliosis or the like. Another therapeutic effect such as an improved gait for the individual may be provided, among other therapeutic effects.

FIG. 1B illustrates a front view of the body 102 of the patient with the plurality of visual indicators 104 positioned on the body 102 depicted in FIG. 1A. Movement of the body 102 to vary the spatial relationship between the at least two of the plurality of visual indicators 104 is performed while the patient is in visual contact with the at least two visual indicators 104. For example, the patient may align visual indicator 104b to be directly above visual indicator 104d while the patient is in visual contact with both visual indicator 104b and visual indicator 104d.

Movement of the body 102 to vary the spatial relationship between the at least two of the plurality of visual indicators 104 may be performed by shifting at least a portion of the body 102. As shown, the patient shifts his or her torso to align visual indicator 104b to be above visual indicator 104d and visual indicator 104a to be above visual indicator 104c. The patient shifts his or her torso towards an improved posture. The patient may receive live-time feedback from the viewing apparatus 106 of the spatial relationship between the at least two visual indicators 104. The shifting of the body 102 moves the body 102 towards an improved posture and counteracts a physical bias of the body 102.

As depicted, the shifting or other movement of the body 102 is performed by the patient. In some embodiments, the shifting or other movement of the body 102 may be performed by a person other than the patient, such as a physical therapist.

Because each visual indictor of the plurality of visual indicators 104 corresponds to a location within the sagittal, the coronal, and the traverse planes, alignment of the at least two visual indicators may be performed on or parallel to at least one of the sagittal, the coronal, or the traverse planes.

Moving the body to vary the spatial relationship between the at least two visual indicators may be performed while at least a portion of the body 102 is in contact with a BOSU® ball, a balance ball, a stability disc, a balance disc, a stability pod, a resistance band, a resistance tube, a foam roller, or stretchable tape. However, other forms of training aids may be used interchangeably according to various embodiments.

FIG. 1C illustrates the patient standing with the viewing apparatus 106 in front of him or her after the spatial relationship between at least two of the visual indicators 104 has been varied. As shown, visual indicator 104b is aligned directly above visual indicator 104d and visual indicator 104a is aligned directly above visual indicator 104c. Also, as shown, visual indicator 104b is aligned directly next to visual indicator 104a and visual indicator 104d is aligned directly next to visual indicator 104c. The patient maintained visual contact with the visual indicators 104 while performing this movement.

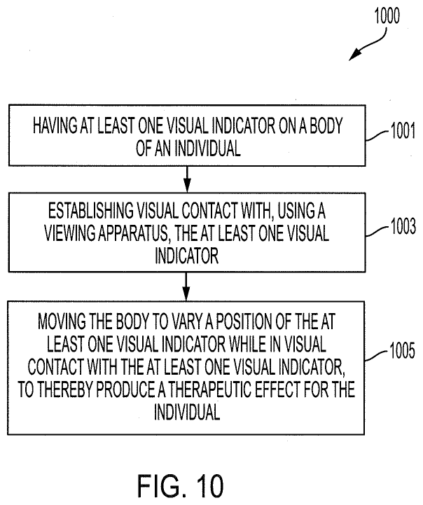

After the spatial relationship between at least two of the visual indicators 104 has been varied, the patient may maintain their body 102 in a stationary position such as the one depicted in FIG. 10. The patient may maintain a spatial relationship between the at least two of the plurality of visual indicators 104 while in visual contact with the at least two of the plurality of visual indicators 104, to thereby produce a therapeutic effect for the patient. In some embodiments, the patient may maintain the new spatial relationship or alignment of the at least two visual indicators while a portion of their body 102 is being moved. The patient may simultaneously move the body 102 and maintain the spatial relationship between the visual indicators 104, while in visual contact with the visual indicators 104. For example, the patient may align at least two visual indicators to produce the posture depicted in FIG. 1C and may maintain that posture while walking towards and away from the viewing apparatus 106.

FIG. 1D illustrates a front view of the body 102 of the patient depicted in FIG. 1A. After the spatial relationship between at least two of the visual indicators 104 has been varied, the above exercise may be performed repeatedly to stimulate the patient's motor system and establish muscle memory, to thereby produce a therapeutic effect for the individual.

The patient may break visual contact with the plurality of visual indicators 104 and allow their body 102 to relax and/or revert to the posture depicted in FIGS. 1A-1B. In some embodiments, the patient may try to hold their body 102 in the new spatial relationship or aligned position after breaking visual contact with the plurality of visual indicators 104 to help stimulate the muscles responsible for the aligned posture.

The patient may re-establish visual contact with the plurality of visual indicators 104 using the viewing apparatus 106. Variation of the spatial relationship between at least two of the visual indicators 104 may be performed again while in visual contact with the at least two visual indicators. For example, visual indicator 104b may again be aligned directly above visual indicator 104d and visual indicator 104a may be aligned directly above visual indicator 104c. As discussed above, alignment of at the least two visual indicators may be performed on or parallel to at least one of the sagittal, the coronal, or the traverse planes. This exercise may be performed multiple times to help establish muscle memory.

The features of method 100 may be utilized with any embodiment of physical therapy method disclosed herein.

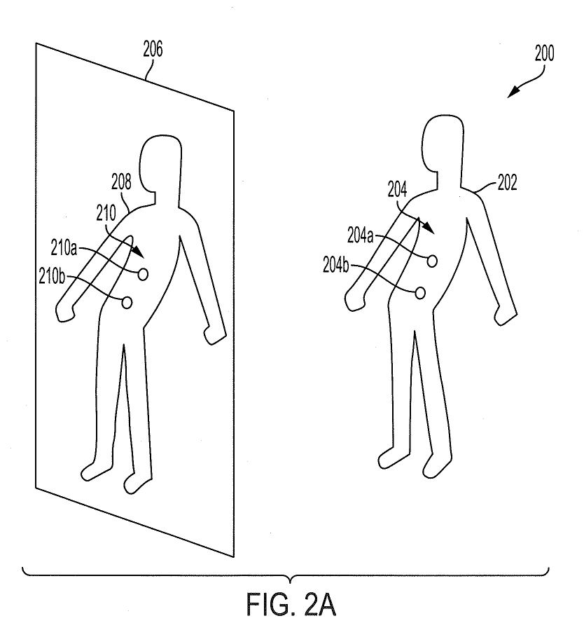

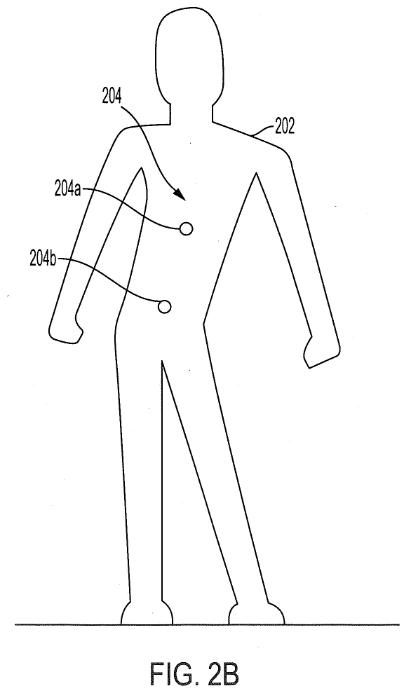

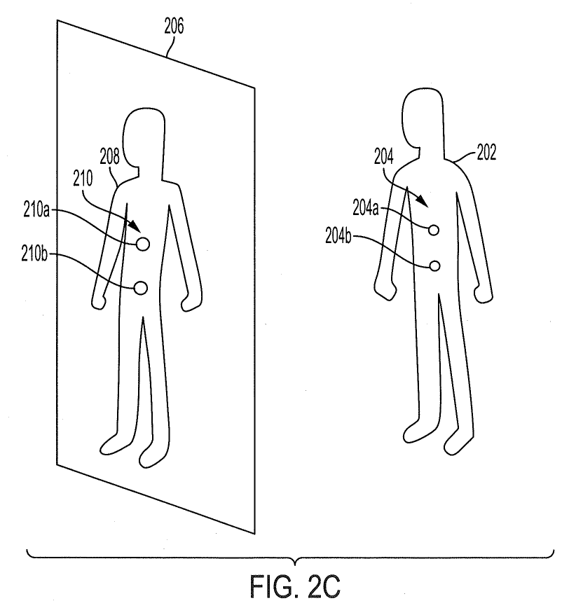

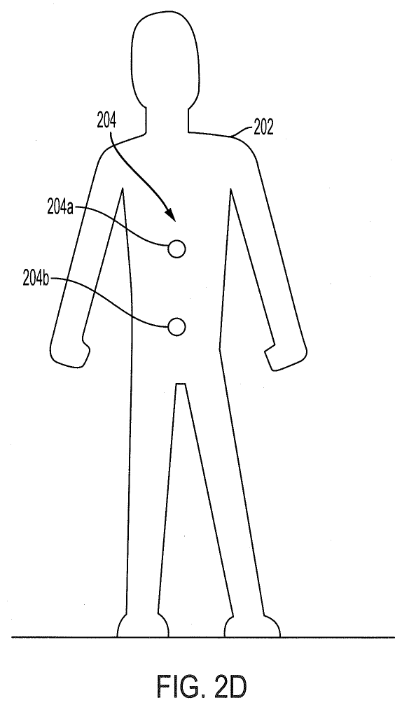

FIGS. 2A-2D illustrate a method 200 for physical therapy according to an embodiment of the present disclosure.

FIG. 2A illustrates a body 202 of a patient with scoliosis with a viewing apparatus 206 in front of them. The body 202 is depicted as having an uneven posture in the form of a cross lateral latency that may be corrected through retraining of the patient's motor system.

A plurality of visual indicators 204 are positioned on the body 202 to provide spatial reference to the patient and/or another individual assisting the patient, such as a physical therapist or other health professional. The plurality of visual indicators 204 are shown to include two visual indicators (204a and 204b). However, any number of visual indicators may be used as desired. Each visual indicator 204a and 204b is positioned on a unique location of the body 202 that corresponds to a location within the sagittal, the coronal, and the transverse planes.

The viewing apparatus 206 is located in front of the patient and is depicted as being a floor length mirror. However, other forms of viewing apparatus may be used as desired. For example, the viewing apparatus may be an electronic screen.

The viewing apparatus 206 reflects the image of the body 202 and the plurality of visual indicators 204 back to the patient. The image of body 202 is reflected back to the patient as body reflection 208. The plurality of visual indicators 204 are similarly reflected back to the patient as visual indicator reflections 210. Visual indicator 204a is reflected back to the patient as visual indicator reflection 210a and visual indicator 204b is reflected back to the patient as visual indicator reflection 210b.

The patient establishes visual contact with visual indicator 204a and visual indicator 204b by viewing visual indicator reflection 210a and visual indicator reflection 210b in the viewing apparatus 206. Once visual contact with visual indicators 204a and 204b is established, movement of the body to vary the spatial relationship of the visual indicators 204a and 204b may occur.

FIG. 2B illustrates a front view of the body 202 of the patient with the plurality of visual indicators 204 positioned on the body 202 depicted in FIG. 2A. Movement of the body to vary a spatial relationship between the visual indicators 204a and 204b is performed while the patient is in visual contact with visual indicators 204a and 204b, to thereby produce a therapeutic effect for the patient.

The variation of the spatial relationship of the visual indicators 204a and 204b may be performed by shifting at least a portion of the body 202. As shown, the patient shifts their torso to align visual indicator 204a to be above visual indicator 204b, to thereby produce a therapeutic effect for the patient. As depicted, the shifting of the body 202 is performed by the patient. In some embodiments, the shifting of the body 202 may be performed by a person other than the patient, such as a physical therapist.

Because visual indicators 204a and 204b each correspond to a location within the sagittal, the coronal, and the traverse planes, alignment of visual indicators 204a and 204b may be performed on or parallel to at least one of the sagittal, the coronal, or the traverse planes.

FIG. 2C illustrates the patient standing with the viewing apparatus 206 in front of them after the variation of the spatial relationship of visual indicators 204a and 204b has been performed. As shown, visual indicator 204a is aligned directly above visual indicator 204b. The visual indicators 204a, 204b are aligned in a vertical plane.

After the variation of the spatial relationship has been performed the patient may maintain their body 202 in a stationary position such as the one depicted in FIG. 2C. In some embodiments, the patient may maintain alignment of visual indicators 204a and 204b while a portion of their body 202 is being moved. For example, the patient may align visual indicators 204a and 204b to produce the posture depicted in FIG. 2C and may maintain that posture while walking towards and away from the viewing apparatus 206.

FIG. 2D illustrates a front view of the body 202 of the patient depicted in FIG. 2A. After the variation of the spatial relationship of visual indicators 204a and 204b has been performed, the exercise may be performed repeatedly to stimulate the patient's motor system to establish muscle memory.

The patient may break visual contact with the plurality of visual indicators 204 and allow the body 202 to relax and/or revert to the posture depicted in FIGS. 2A-2B. In some embodiments, the patient may try to hold their body 202 in a maintained position after breaking visual contact with visual indicators 204a and 204b to help stimulate the muscles responsible for the aligned posture.

The patient may re-establish visual contact with the plurality of visual indicators 204a and 204b using the viewing apparatus 206. A variation of the spatial relationship of visual indicators 204a and 204b may be performed again while in visual contact with visual indicators 204a and 204b. As discussed above, alignment of at the least two visual indicators may be performed on or parallel to at least one of the sagittal, the coronal, or the traverse planes. This exercise may be performed multiple times to help establish muscle memory.

The features of method 200 may be utilized with any embodiment of physical therapy method disclosed herein.

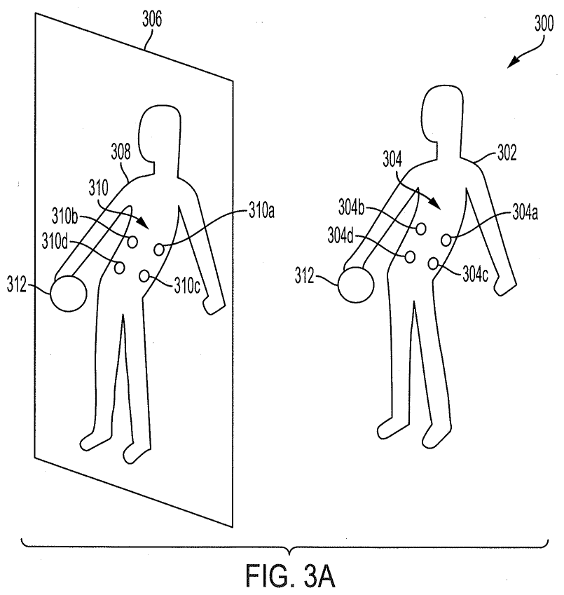

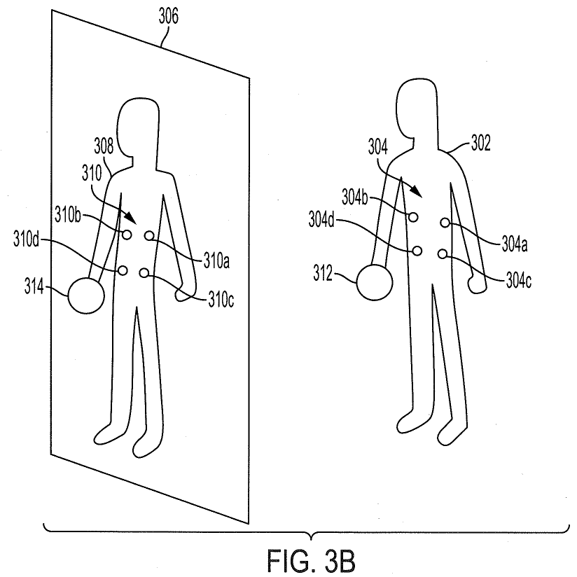

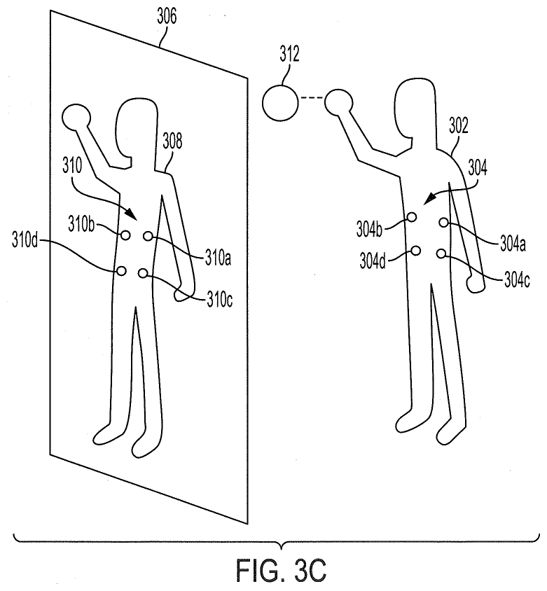

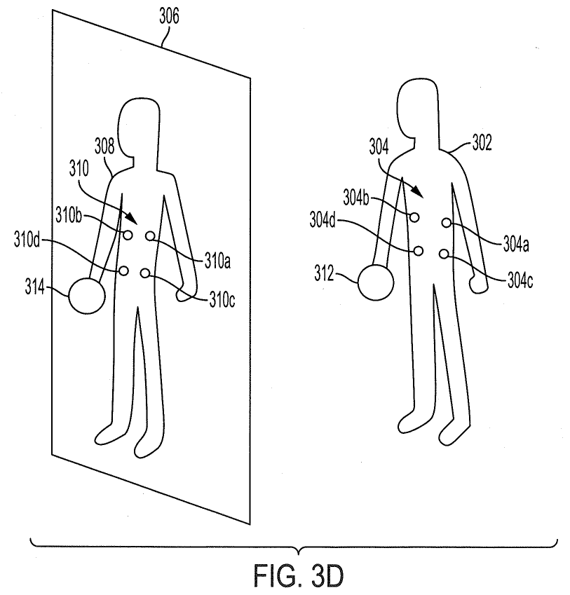

FIGS. 3A-3D illustrate a method 300 for physical therapy according to an embodiment of the present disclosure.

FIG. 3A illustrates a body 302 of a patient with scoliosis holding a ball 312 with a viewing apparatus 306 in front of them. A plurality of visual indicators 304 are positioned on the body 302 to provide spatial reference to the patient and/or someone assisting the patient, such as a physical therapist or other health professional.

The plurality of visual indicators 304 are shown to include four visual indicators (304a, 304b, 304c, and 304d). However, any number of visual indicators may be used according to various embodiments. Each visual indicator 304a, 304b, 304c, and 304d is positioned on a unique location of the body 302 that corresponds to a location within the sagittal, the coronal, and the transverse planes.

The viewing apparatus 306 is located in front of the patient and is depicted as being a floor length mirror. However, other forms of viewing apparatus may be used as desired. For example, the viewing apparatus may be an electronic screen.

The viewing apparatus 306 reflects the image of the body 302 and the plurality of visual indicators 304 back to the patient. The image of body 302 is reflected back to the patient as body reflection 308. The plurality of visual indicators 304 are similarly reflected back to the patient as visual indicator reflections 310. Visual indicator 304a is reflected back to the patient as visual indicator reflection 310a. Visual indicator 304b is reflected back to the patient as visual indicator reflection 310b. Visual indicator 304c is reflected back to the patient as visual indicator reflection 310c. Visual indicator 304d is reflected back to the patient as visual indicator reflection 310d.

The patient establishes visual contact with at least two visual indicators of the plurality of visual indicators 304. As depicted, the patient establishes visual contact with at least two visual indicators by viewing each of the associated visual indicator reflections (310a, 310b, 310c, and 310d) in the viewing apparatus 306. Once visual contact with the at least two visual indicators is established, movement of the body to vary the spatial relationship of the at least two visual indicators may occur.

FIG. 3B illustrates the patient holding the ball 312 with the viewing apparatus 306 in front of them after the body has been moved to vary a spatial relationship between the at least two of the plurality of visual indicators 304 while in visual contact with the at least two of the plurality of visual indicators 304. As shown, visual indicator 304b is aligned directly above visual indicator 304d and visual indicator 304a is aligned directly above visual indicator 304c. Also, as shown, visual indicator 304b is aligned directly next to visual indicator 304a and visual indicator 304d is aligned directly next to visual indicator 304c.

The variation of the spatial relationship of the visual indicators 304 is performed while the patient is in visual contact with the at least two visual indicators. For example, the patient may align visual indicator 304b to be directly above visual indicator 304d while the patient is in visual contact with both visual indicator 304b and visual indicator 304d.

The variation of the spatial relationship of the visual indicators 304 is performed by shifting at least a portion of the body 302. As shown, the patient shifts their torso to align visual indicator 304b to be above visual indicator 304d and visual indicator 304a to be above visual indicator 304c.

As depicted, the shifting of the body 302 is performed by the patient. In some embodiments, the shifting of the body 302 may be performed by a person other than the patient, such as a physical therapist.

Because each visual indictor of the plurality of visual indicators 304 corresponds to a location within the sagittal, the coronal, and the traverse planes, alignment of the at least two visual indicators may be performed on or parallel to at least one of the sagittal, the coronal, or the traverse planes.

The variation of the spatial relationship of the visual indicators 304 may be performed while at least a portion of the body 302 is in contact with a BOSU® ball, a balance ball, a stability disc, a balance disc, a stability pod, a resistance band, a resistance tube, a foam roller, or stretchable tape. However, other forms of training aids may be used interchangeably according to various embodiments.

FIG. 3C illustrates the patient bouncing the ball 312 off of the viewing apparatus 306 after alignment of the at least two visual indicators have been performed. In other embodiments, the patient may bounce the ball 312 off another object other than the viewing apparatus 306, such as another viewing apparatus or a wall.

Between throwing the ball 312 and catching the ball 312, the patient's body 302 may relax and/or revert to the posture depicted in FIG. 3A. In some embodiments, after catching the ball 312, the patient's posture may be in a different position than the posture depicted in FIG. 3A.

After the patient has caught the ball 312, the patient may re-establish visual contact with the plurality of visual indicators 304 using the viewing apparatus 306. The patient may move the body to vary the spatial relationship between the at least two of the plurality of visual indicators while in visual contact with the at least two of the plurality of visual indicators, to thereby produce a therapeutic effect for the individual. Alignment of the at least two visual indicators may be performed again while in visual contact with the at least two visual indicators. For example, visual indicator 304b may be aligned directly above visual indicator 304d and visual indicator 304a may be aligned directly above visual indicator 304c. As discussed above, alignment of at the least two visual indicators may be performed on or parallel to at least one of the sagittal, the coronal, or the traverse planes. This exercise may be performed multiple times to help establish muscle memory.

FIG. 3D illustrates the patient holding the ball 312 after alignment of the at least two visual indicators has been performed. The above exercise may be performed repeatedly to stimulate the patient's motor system to establish muscle memory.

The features of method 300 may be utilized with any embodiment of physical therapy method disclosed herein.

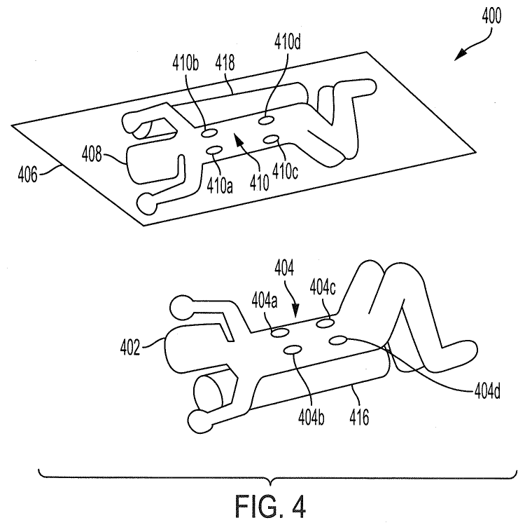

FIG. 4 illustrates a method 400 for physical therapy according to an embodiment of the present disclosure. A body 402 of a patient is balancing on a foam roller 416 while underneath a viewing apparatus 406.

A plurality of visual indicators 404 are positioned on the body 402 to provide spatial reference to the patient and/or another individual assisting the patient, such as a physical therapist or other health professional. By providing spatial orientation at various points on the body 402, adjustments to the patient's posture and/or movements may be made by moving the body to vary a spatial relationship between at least two of the plurality of visual indicators 404 while in visual contact with the at least two of the plurality of visual indicators. A therapeutic effect may result from the motion.

The plurality of visual indicators 404 are shown to include four visual indicators (404a, 404b, 404c, and 404d). However, any number of visual indicators may be used as desired. Each visual indicator 404a, 404b, 404c, and 404d is positioned on a unique location of the body 402 that corresponds to a location within the sagittal, the coronal, and the transverse planes.

The viewing apparatus 406 is located above the patient and is depicted as being a ceiling mirror. However, other forms of viewing apparatus may be used as desired. For example, the viewing apparatus may be an electronic screen.

The viewing apparatus 406 reflects the image of the body 402 and the plurality of visual indicators 404 back to the patient. The image of body 402 is reflected back to the patient as body reflection 408. The plurality of visual indicators 404 are similarly reflected back to the patient as visual indicator reflections 410. Visual indicator 404a is reflected back to the patient as visual indicator reflection 410a. Visual indicator 404b is reflected back to the patient as visual indicator reflection 410b. Visual indicator 404c is reflected back to the patient as visual indicator reflection 410c. Visual indicator 404d is reflected back to the patient as visual indicator reflection 410d.

The patient establishes visual contact with at least two visual indicators within the plurality of visual indicators 404. As depicted, the patient establishes visual contact with the at least two visual indicators by viewing each of the associated visual indicator reflections (410a, 410b, 410c, and 410d) in the viewing apparatus 406. Once visual contact with the at least two visual indicators is established, alignment of the at least two visual indicators occurs.

The variation of the spatial relationship of the visual indicators is performed while the patient is in visual contact with at least two visual indicators. For example, the patient may align visual indicator 404b to be aligned in a vertical plane with visual indicator 404d while the patient is in visual contact with both visual indicator 404b and visual indicator 404d.

As depicted, alignment is performed while the patient is balancing on the foam roller 416. However, other balancing aids such as a BOSU® ball, a balance ball, a stability disc, a balance disc, or a stability pod may be used interchangeably according to various embodiments.

After the variation of the spatial relationship of the visual indicators has been performed the patient may maintain alignment of the at least two visual indicators while their body 402 is being balanced. In some embodiments, the patient may maintain alignment of the at least two visual indicators while simultaneously balancing on the foam roller 416 and moving at least a portion of their body 402. For example, the patient may align at least two visual indicators and maintain alignment of the at least two visual indicators as the patient moves their body 402 to roll to their left and roll to their right.

The features of method 400 may be utilized with any embodiment of physical therapy method disclosed herein.

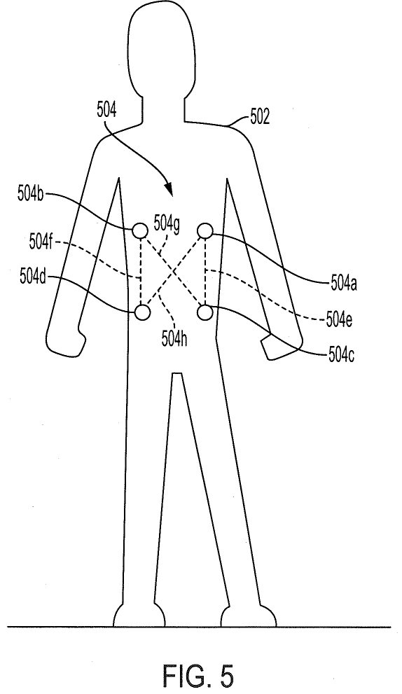

FIG. 5 illustrates a plurality of visual indicators 504 for a physical therapy method according to an embodiment of the present disclosure.

The plurality of visual indicators 504 are shown to be positioned on a body 502 of a patient to provide spatial reference to the patient and/or another individual assisting the patient, such as a physical therapist or other health professional.

The plurality of visual indicators 504 are shown to include eight visual indicators (504a, 504b, 504c, 504d, 504e, 504f, 504g, and 504h). However, any number of visual indicators may be used as desired (a greater or lesser number of visual indicators). Each visual indicator 504a, 504b, 504c, 504d, 504e, 504f, 504g, and 504h is positioned on a unique location of the body.

The visual indicators 504a, 504b, 504c, and 504d are depicted as being circular in shape. However, other geometric shapes may be used as desired. The visual indicators 504a, 504b, 504c, and 504d may be in two-dimensional form or three-dimensional form.

The visual indicators 504e, 504f, 504g, and 504h are depicted as being dotted lines. However, other configurations may be used interchangeably according to various embodiments. For example, visual indicators 504e, 504f, 504g, and 504h may be in the form of solid lines.

The visual indicators 504a, 504b, 504c, 504d, 504e, 504f, 504g, and 504h may have a single color or include a mixture of colors. In some embodiments, the visual indicators 504a, 504b, 504c, 504d, 504e, 504f, 504g, and 504h may include a geometric pattern to assist the patient in quickly locating the visual indicators 504a, 504b, 504c, 504d, 504e, 504f, 504g, and 504h on their body 502. The visual indicators 504a, 504b, 504c, 504d, 504e, 504f, 504g, and 504h may have a matte surface or a reflective surface to allow the patient to align the visual indicators 504a, 504b, 504c, 504d, 504e, 504f, 504g, and 504h under various lighting conditions. For example, under poor lighting conditions a reflective surface may be used.

The visual indicators 504 in the form of lines 504e, 504f, 504g, and 504h may be utilized in any embodiment of method disclosed herein. The visual indicators 504 in the form of lines 504e, 504f, 504g, and 504h may be moved when the body 502 is moved to vary the spatial relationship between the visual indicators 504e, 504f, 504g, and 504h. For example, the body 502 may be moved to vary the spatial relationship between at least two of the plurality of visual indicators 504e, 504f, 504g, and 504h, which may include moving at least two of the plurality of visual indicators 504e, 504f, 504g, and 504h towards having a similar length. An individual may provide instruction for the body 502 to be moved such that at least two of the plurality of visual indicators 504e, 504f, 504g, and 504h are moved towards having a similar length.

The features of visual indicators 504 may be utilized with any embodiment of physical therapy method disclosed herein.

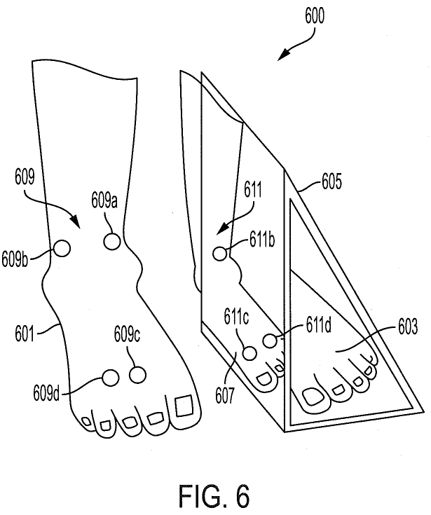

FIG. 6 illustrates a method 600 for physical therapy according to an embodiment of the present disclosure. A patient's body, in the form of a right foot 601, is in front of a viewing apparatus 605.

A plurality of visual indicators 609 are first positioned on the patient's right foot 601 to provide spatial reference to the patient and/or another individual assisting the patient, such as a physical therapist or other health professional. By providing spatial reference at various points on the patient's right foot 601, adjustments to the right foot's 601 movements may be made by moving the body to vary a spatial relationship between at least two of the plurality of visual indicators 609 while in visual contact with at least two of the plurality of visual indicators 609. A therapeutic effect may result from the motion. For example, an improved gait or posture may result. The therapeutic effect may include a patient being able to better perform a movement.

The plurality of visual indicators 609 are shown to include four visual indicators (609a, 609b, 609c, and 609d). However, any number of visual indicators may be used as desired. Each visual indicator 609a, 609b, 609c, and 609d is positioned on a unique location of the patient's right foot 601 that corresponds to a location within the sagittal, the coronal, and the transverse planes.

The viewing apparatus 605 is depicted as being a mirror box. However, other forms of viewing apparatus may be used as desired. For example, the viewing apparatus 605 may be an electronic screen. The patient's left foot 603 is depicted is being within the viewing apparatus 605.

The viewing apparatus 605 reflects the image of the patient's right foot 601 and the plurality of visual indicators 609 back to the patient. The image of the patient's right foot 601 is reflected back to the patient as right foot reflection 607. The plurality of visual indicators 609 are similarly reflected back to the patient as visual indicator reflections 611. Visual indicator 609b is reflected back to the patient as visual indicator reflection 611b. Visual indicator 609c is reflected back to the patient as visual indicator reflection 611c. Visual indicator 609d is reflected back to the patient as visual indicator reflection 611d.

The patient establishes visual contact with at least two visual indicators within the plurality of visual indicators 609. As depicted, the patient establishes visual contact with the at least two visual indicators by viewing each of the associated visual indicator reflections in the viewing apparatus 605. Once visual contact with the at least two visual indicators is established, movement of the spatial relationship between at least two visual indicators may occur.

The variation of the spatial relationship of the visual indicators is performed while the patient is in visual contact with the at least two visual indicators. For example, the patient may raise visual indicator 609d relative to visual indicator 609b (i.e., pivot his or her foot upward) while the patient is in visual contact with both visual indicator 609d and visual indicator 609b.

The features of method 600 may be utilized with any embodiment of physical therapy method disclosed herein.

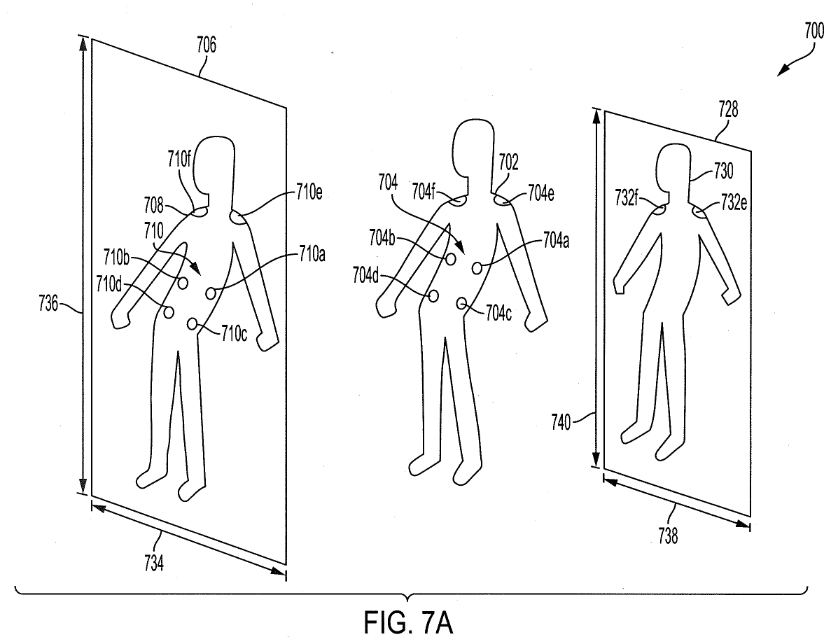

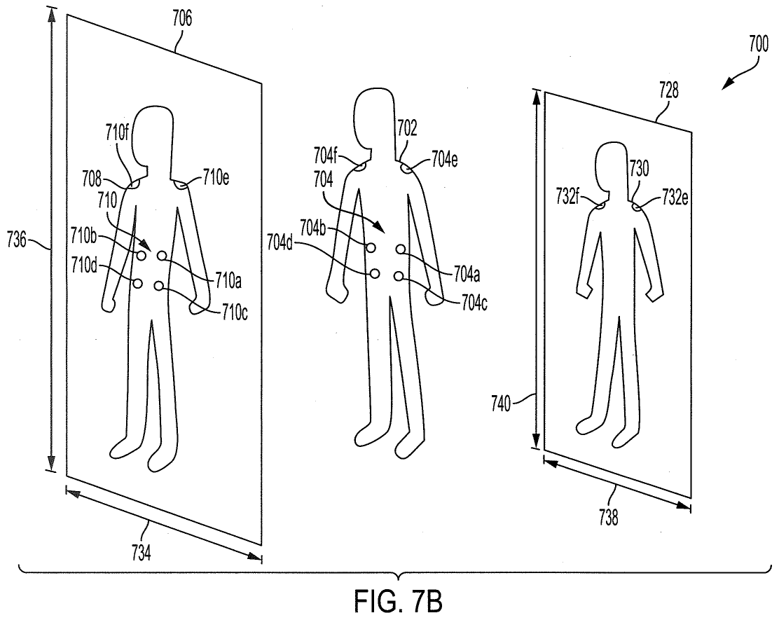

FIGS. 7A-7B illustrate a method 700 for physical therapy according to an embodiment of the present disclosure.

FIG. 7A illustrates a body 702 of a patient with scoliosis with a first viewing apparatus 706 in front of them and a second viewing apparatus 728 behind them.

A plurality of visual indicators 704 are positioned on the body 702 to provide spatial reference to the patient and/or another individual assisting the patient, such as a physical therapist or other health professional. By providing spatial reference at various points on the body 702, adjustments to the patient's posture and/or movements may be made by moving the body to vary a spatial relationship between at least two of the plurality of visual indicators 704 while in visual contact with at least two of the plurality of visual indicators 704.

The plurality of visual indicators 704 are shown to include six visual indicators (704a, 704b, 704c, 704d, 704e, and 704f). However, any number of visual indicators may be used according to various embodiments. Each visual indicator 704a, 704b, 704c, 704d, 704e, and 704f is positioned on a unique location of the body 702 that corresponds to a location within the sagittal, the coronal, and the transverse planes.

The first viewing apparatus 706 is located in front of the patient and is depicted as being a floor length mirror having a width 734 and a height 736. However, other forms of viewing apparatus may be used as desired. For example, the first viewing 706 apparatus may be an electronic screen.

The second viewing apparatus 728 is located behind the patient and is depicted as being a floor length mirror having a width 738 and a height 740. However, other forms of viewing apparatus may be used as desired. For example, the second viewing apparatus 728 may be an electronic screen. The height 740 of the second viewing apparatus 728 may be the same as the height 736 of the first viewing apparatus 706. In other embodiments, the height 736 of the first viewing apparatus 706 may be taller than the height 740 of the second viewing apparatus 728.

The first viewing apparatus 706 reflects the image of body 702 back to the patient as body reflection 708. Visual indicator 704a is reflected back to the patient as visual indicator reflection 710a. Visual indicator 704b is reflected back to the patient as visual indicator reflection 710b. Visual indicator 704c is reflected back to the patient as visual indicator reflection 710c. Visual indicator 704d is reflected back to the patient as visual indicator reflection 710d.

The second viewing apparatus 728 reflects the image of body 702 back to the patient as body reflection 730. Visual indicator 704e is reflected back to the patient as visual indicator reflection 732e. Visual indicator 704f is reflected back to the patient as visual indicator reflection 732f.

The patient establishes visual contact with at least two visual indicators within the plurality of visual indicators 704. As depicted, the patient establishes visual contact with the at least two visual indicators by viewing each of the associated visual indicator reflections (704a, 704b, 704c, 704d, 704e, and 704f) in their respective viewing apparatus (706 and 728). Once visual contact with the at least two visual indicators is established, movement of the body to vary the spatial relationship between the at least two of the plurality of visual indicators may occur.

FIG. 7B illustrates the patient with the first viewing apparatus 706 in front of them and the second viewing apparatus 728 behind them after the body 702 has been moved to vary a spatial relationship between at least two of the plurality of visual indicators 704 while in visual contact with at least two of the plurality of visual indicators 704. As shown, visual indicator 704b is aligned directly above visual indicator 704d and visual indicator 704a is aligned directly above visual indicator 704c. Also, as shown, visual indicator 704b is aligned directly next to visual indicator 704a and visual indicator 704d is aligned directly next to visual indicator 704c. Visual indicators 704f and 704e may be moved to a raised position to improve a posture of the patient or better allow a patient to perform a movement.

The features of method 700 may be utilized with any embodiment of physical therapy method disclosed herein.

In one embodiment, only one, or at least one, visual indicator may be utilized. The individual may establish visual contact with, using a viewing apparatus, the at least one visual indicator. The individual may move his or her body to vary a position of the at least one visual indicator while in visual contact with the at least one visual indicator, to thereby produce a therapeutic effect for the individual. For example, the individual may view only one visual indicator while moving his or her body. The view of the visual indicator may provide the live-time feedback on the position of the individual's body, which may beneficially train the motor system of the body and may provide other benefits disclosed herein. Another individual may provide instruction indicating a desired variation of the position of the at least one visual indicator. The features of any other method disclosed herein may be utilized with this method.

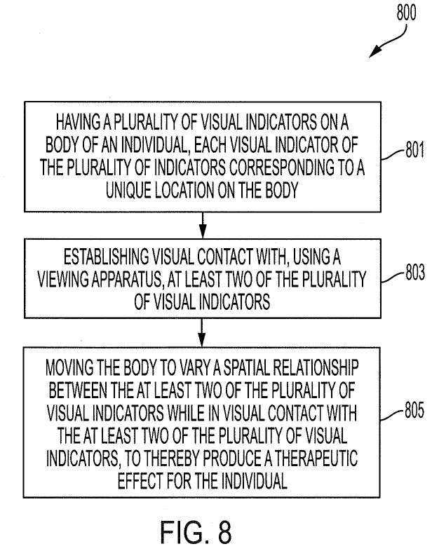

FIG. 8 is a flowchart for a method 800 for physical therapy according to an embodiment of the present disclosure.

A body of an individual may have a plurality of visual indicators (e.g., plurality of visual indicators 104, 204, 304, 404, 504, 609, 704) positioned on the body (e.g., body 102, 202, 302, 402, 502, 601, 702) (Step 801). In some embodiments, the plurality of visual indicators on the body may include one or more stickers. In other embodiments, the plurality of visual indicators may be drawn on the body.

Visual contact is established with, using a viewing apparatus (e.g., viewing apparatus 106, 206, 306, 406, 605, 706, 728) at least two visual indicators of the plurality of visual indicators (Step 803). In some embodiments, the viewing apparatus may be a mirror box. In other embodiments, the viewing apparatus may be at least one mirror. In other embodiments, other viewing apparatuses may be utilized.

The body may be moved to vary a spatial relationship between the at least two of the plurality of visual indicators while in visual contact with the at least two of the plurality of visual indicators, to thereby produce a therapeutic effect for the individual (Step 805). An alignment of the at least two visual indicators may be performed by shifting at least a portion of the body. An alignment may be performed while at least a portion of the body is in contact with a BOSU® ball, a balance ball, a stability disc, a balance disc, a stability pod, a resistance band, a resistance tube, foam roller, or stretchable tape. However, other forms of training aids may be used interchangeably according to various embodiments.

In some embodiments, visual contact may be broken with the at least two visual indicators. Visual contact may then be re-established with, using the viewing apparatus, the at least two visual indicators. After visual contact is re-established, alignment of the at least two visual indicators may be made while in visual contact with the at least two visual indicators.

In some embodiments, the body may be balanced on at least one of a BOSU® ball, a balance ball, a stability disc, a balance disc, a stability pod, or a foam roller. While the body is being balanced the spatial relationship or alignment of the at least two visual indicators may be maintained. In other embodiments, the body may be moved and the spatial relationship of the at least two visual indicators may be maintained while the body is being moved.

The features of method 800 may be utilized with any embodiment of physical therapy method disclosed herein.

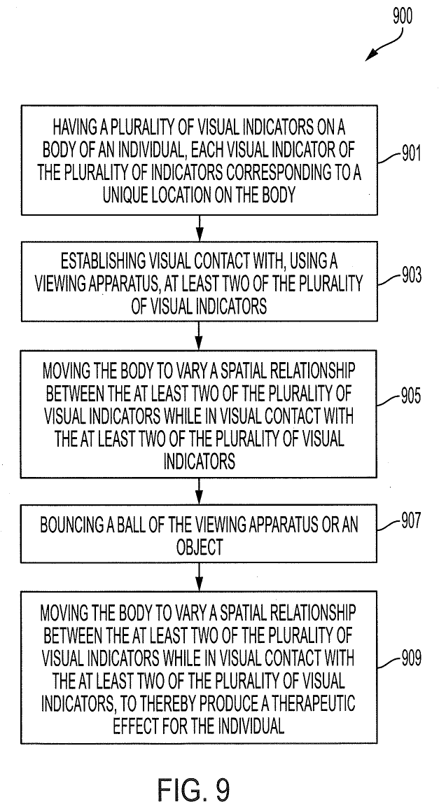

FIG. 9 is a flowchart for a method 900 for physical therapy according to an embodiment of the present disclosure.

A body of an individual may have a plurality of visual indicators (e.g., plurality of visual indicators 104, 204, 304, 404, 504, 609, 704) positioned on the body (e.g., body 102, 202, 302, 402, 502, 601, 702) (Step 901). In some embodiments, the plurality of visual indicators on the body may include one or more stickers. In other embodiments, the plurality of visual indicators may be drawn on the body.

Visual contact is established with, using a viewing apparatus (e.g., viewing apparatus 106, 206, 306, 406, 605, 706, 728), at least two visual indicators of the plurality of visual indicators (Step 903). In some embodiments, the viewing apparatus may be a mirror box. In other embodiments, the viewing apparatus may be at least one mirror. In other embodiments, other viewing apparatuses may be utilized.

The body may be moved to vary a spatial relationship between the at least two of the plurality of visual indicators while in visual contact with the at least two of the plurality of visual indicators (Step 905). An alignment of the at least two visual indicators may be performed by shifting at least a portion of the body. An alignment may be performed while at least a portion of the body is in contact with a BOSU® ball, a balance ball, a stability disc, a balance disc, a stability pod, a resistance band, a resistance tube, foam roller, or stretchable tape. However, other forms of training aids may be used interchangeably according to various embodiments.

After movement of the body is made, a ball may bounce off of the viewing apparatus or an object (Step 907). In some embodiments the object may be a mirror. In other embodiments the object may be a different structure or device.

After the ball is bounced off of an object, the body may be moved to vary the spatial relationship between the at least two of the plurality of visual indicators while in visual contact with the at least two of the plurality of visual indicators, to thereby produce a therapeutic effect for the individual (Step 909).

The features of method 900 may be utilized with any embodiment of physical therapy method disclosed herein.

FIG. 10 is a flowchart for a method 1000 for physical therapy according to an embodiment of the present disclosure.

A body of an individual may have at least one visual indicator (e.g., visual indicator 104, 204, 304, 404, 504, 609, 704) that is positioned on the body (e.g., body 102, 202, 302, 402, 502, 601, 702) (Step 1001).

Visual contact is established with, using a viewing apparatus (e.g., viewing apparatus 106, 206, 306, 406, 605, 706, 728) the at least one visual indicator (Step 1003).

The body may be moved to vary a position of the at least one visual indicator while in visual contact with the at least one visual indicator, to thereby produce a therapeutic effect for the individual (Step 1005).

The features of method 1000 may be utilized with any embodiment of physical therapy method disclosed herein.

The methods disclosed herein are not solely for practice by the individual or patient, but may include methods performed by another individual, who may comprise an individual assisting the patient, such as a physical therapist or other health professional. The other individual may provide instruction to the individual (such as a patient or physical therapy patient) other otherwise assist regarding any method disclosed herein.

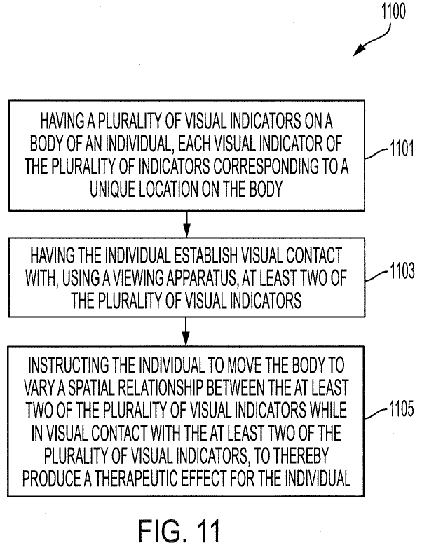

FIG. 11 is a flowchart for a method 1100 for physical therapy according to an embodiment of the present disclosure.

A body of an individual may have a plurality of visual indicators (e.g., visual indicator 104, 204, 304, 404, 504, 609, 704) that is positioned on the body (e.g., body 102, 202, 302, 402, 502, 601, 702) (Step 1101). Each visual indicator may correspond to a unique location on the body.

The method may include having the individual establish visual contact with, using a viewing apparatus (e.g., viewing apparatus 106, 206, 306, 406, 605, 706, 728), at least two of the plurality of visual indicators (Step 1103).

The method may include instructing the individual to move the body to vary a spatial relationship between the at least two of the plurality of visual indicators while in visual contact with the at least two of the plurality of visual indicators, to thereby produce a therapeutic effect for the individual (Step 1105). The instruction may be performed by a physical therapist or other individual, and this method may be performed by a physical therapist or other individual.

The features of method 1100 may be utilized with any embodiment of physical therapy method disclosed herein.

In other embodiments, the methods disclosed herein may be performed solely by the individual or patient as appropriate.

In embodiments herein, the visual indicators may be positioned on locations other than specifically disclosed herein. For example, the visual indicators may be positioned on any part of the body, for example the torso, legs, arms, neck, head, hands, or other parts.

The methods disclosed herein may be combined, modified, substituted, or otherwise altered as desired. Features of one embodiment may be utilized with another embodiment as desired.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of systems, apparatuses, and methods as disclosed herein, which is defined solely by the claims. Accordingly, the systems, apparatuses, and methods are not limited to that precisely as shown and described.

Certain embodiments of systems, apparatuses, and methods are described herein, including the best mode known to the inventors for carrying out the same. Of course, variations on these described embodiments will become apparent to those of ordinary skill in the art upon reading the foregoing description. The inventor expects skilled artisans to employ such variations as appropriate, and the inventors intend for the systems, apparatuses, and methods to be practiced otherwise than specifically described herein. Accordingly, the systems, apparatuses, and methods include all modifications and equivalents of the subject matter recited in the claims appended hereto as permitted by applicable law. Moreover, any combination of the above-described embodiments in all possible variations thereof is encompassed by the systems, apparatuses, and methods unless otherwise indicated herein or otherwise clearly contradicted by context.

Groupings of alternative embodiments, elements, or steps of the systems, apparatuses, and methods are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses an approximation that may vary, yet is capable of performing the desired operation or process discussed herein.

The terms “a,” “an,” “the” and similar referents used in the context of describing the systems, apparatuses, and methods (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the systems, apparatuses, and methods and does not pose a limitation on the scope of the systems, apparatuses, and methods otherwise claimed. No language in the present specification should be construed as indicating any non-claimed element essential to the practice of the systems, apparatuses, and methods.

All patents, patent publications, and other publications referenced and identified in the present specification are individually and expressly incorporated herein by reference in their entirety for the purpose of describing and disclosing, for example, the compositions and methodologies described in such publications that might be used in connection with the systems, apparatuses, and methods. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

What is claimed is:

1. A method for physical therapy comprising:
having a plurality of visual indicators on a body of an individual, each visual indicator of the plurality of visual indicators corresponding to a unique location on the body;
establishing visual contact with, using a viewing apparatus, at least two of the plurality of visual indicators; and
moving the body to vary a spatial relationship between the at least two of the plurality of visual indicators while in visual contact with the at least two of the plurality of visual indicators, to thereby produce a therapeutic effect for the individual.

2. The method of claim 1, wherein varying the spatial relationship between the at least two of the plurality of visual indicators includes aligning the at least two of the plurality of visual indicators.

3. The method of claim 2, wherein aligning the at least two of the plurality of visual indicators includes aligning the at least two of the plurality of visual indicators on a plane.

4. The method of claim 3, wherein the plane is defined by an instruction provided to the individual, and is on or parallel to one of a sagittal plane, a coronal plane, or a transverse plane of the body of the individual.

5. The method of claim 1, wherein varying the spatial relationship between the at least two of the plurality of visual indicators includes moving the at least two of the plurality of visual indicators towards having a similar length, and wherein moving the body includes moving the body towards an improved posture.

6. The method of claim 1, wherein moving the body includes moving the body to counteract a physical bias of the body.

7. The method of claim 1, wherein the therapeutic effect comprises one or more of an improved posture or gait for the individual.

8. The method of claim 1, further comprising maintaining a spatial relationship between the at least two of the plurality of visual indicators while in visual contact with the at least two of the plurality of visual indicators, to thereby produce a therapeutic effect for the individual.

9. The method of claim 8, wherein maintaining the spatial relationship is performed while at least a portion of the body is in contact with at least one of a BOSU° ball, a balance ball, a stability disc, a balance disc, a stability pod, a resistance band, a resistance tube, a foam roller, or stretchable tape.

10. The method of claim 1, further comprising:
breaking visual contact with the at least two visual indicators;
reverting the body to a posture;
re-establishing visual contact with, using the viewing apparatus, the at least two visual indicators; and
varying the spatial relationship between the at least two visual indicators while in visual contact with the at least two visual indicators.

11. The method of claim 1, wherein the plurality of visual indicators comprise one or more stickers or are drawn on the body.

12. The method of claim 1, wherein varying the spatial relationship between the at least two of the plurality of visual indicators is performed while the body is in contact with at least one of a BOSU® ball, a balance ball, a stability disc, a balance disc, a stability pod, a resistance band, a resistance tube, a foam roller, or stretchable tape, and the method further comprises moving the body and simultaneously maintaining a spatial relationship between the at least two of the plurality of visual indicators while in visual contact with the at least two of the plurality of visual indicators.

13. The method of claim 1, wherein the viewing apparatus comprises at least one mirror, and the method further comprises:
balancing the body on at least one of a BOSU® ball, a balance ball, a stability disc, a balance disc, a stability pod, or a foam roller; and
maintaining a spatial relationship between the at least two of the plurality of visual indicators while the body is being balanced.

14. A method for physical therapy comprising:
having a plurality of visual indicators on a body of an individual, each visual indicator of the plurality of visual indicators corresponding to a unique location on the body;
establishing visual contact with, using a viewing apparatus, at least two visual indicators of the plurality of visual indicators;
moving the body to vary a spatial relationship between the at least two of the plurality of visual indicators while in visual contact with the at least two of the plurality of visual indicators;
bouncing a ball off the viewing apparatus or an object; and
moving the body to vary the spatial relationship between the at least two of the plurality of visual indicators while in visual contact with the at least two of the plurality of visual indicators, to thereby produce a therapeutic effect for the individual.

15. The method of claim 14, wherein the viewing apparatus comprises a first mirror and a second mirror.

16. The method of claim 14, wherein the object is a mirror.

17. The method of claim 14, further comprising catching the ball after the ball has been bounced off the viewing apparatus or the object.

18. A method for physical therapy comprising:
having at least one visual indicator on a body of an individual;
establishing visual contact with, using a viewing apparatus, the at least one visual indicator; and
moving the body to vary a position of the at least one visual indicator while in visual contact with the at least one visual indicator, to thereby produce a therapeutic effect for the individual.

19. The method of claim 18, further comprising receiving instruction from another individual indicating a desired variation of the position of the at least one visual indicator.

20. The method of claim 19, wherein moving the body to vary the position of the at least one visual indicator while in visual contact with at least one visual includes receiving live-time feedback from the viewing apparatus of the position of the at least one visual indicator, and the therapeutic effect comprises one or more of an improved posture or gait for the individual.
